(19) United States
(12) Patent Application Publication
(10) Pub. No.: US 2023/0393419 A1
(43) Pub. Date: Dec. 7, 2023

(54) Disposable Film for Modifying a Property of an Eyeglass Lens

(71) Applicant: Marcus Boggs, Steamboat Springs, CO (US)

(72) Inventor: Marcus Boggs, Steamboat Springs, CO (US)

(21) Appl. No.: 18/210,745

(22) Filed: Jun. 16, 2023

Related U.S. Application Data
(62) Division of application No. 17/011,118, filed on Sep. 3, 2020.
(60) Provisional application No. 62/896,823, filed on Sep. 6, 2019.

(51) Int. Cl. G02C 7/10; B29D 11/00; G02C 7/12

(52) U.S. Cl. CPC G02C 7/10; G02C 7/101; B26F 1/40; G02C 7/12; B29D 11/00432

(57) ABSTRACT

The present invention provides an apparatus for modifying a property of an eyeglass lens. The apparatus includes a transparent polymer film capable absorbing or reflecting UVA and/or UVB radiation. The film is sized and shaped for attachment to a surface the eyeglass lens.

### BACKGROUND OF INVENTION

Hundreds of millions of people around the world wear prescription glasses of some type. Unless these prescription glasses are provisioned with technology that provides UV protection and/or changes the tint at varying light conditions (e.g. such as Transition™ lens technology), the normal prescription eyeglass user will typically carry at least two sets of prescription glasses with them which accommodate different light conditions (e.g. inside/night time light conditions and outside/day time light conditions). It would be most useful if a normal prescription eyeglass user (e.g. with normal non-Transition™ based glasses) could carry and use one set of glasses which could be satisfactory for all light conditions encountered throughout the day (e.g. inside/nighttime light conditions and outside/day time light conditions).

### BRIEF SUMMARY OF THE INVENTION

The present invention solves the problems noted above and others. The present invention provides the ability for a normal prescription eyeglass user to carry and use one set of glasses which are satisfactory for all light conditions encountered throughout their day (e.g. inside/nighttime light conditions and outside/daytime light conditions).

In a first embodiment, the present invention provides an apparatus for modifying a property of an eyeglass lens. The apparatus comprises a transparent polymer film capable absorbing or reflecting UVA and/or UVB radiation. The film is sized and shaped for attachment to a surface the eyeglass lens.

In a second embodiment, the present invention provides an eyeglass combination comprising an eyeglass lens and an apparatus for modifying a property of an eyeglass lens as described above. The apparatus is attached to the lens via electrostatic attraction.

In a third embodiment, the present invention provides a kit comprising a plurality of apparatuses for modifying a property of an eyeglass lens as described above. The plurality of apparatuses are arranged in a stacked configuration (e.g. in stacked one on top of each other's major surfaces).

In a fourth embodiment, the present invention provides a method of imparting an electrostatic charge to an apparatus for modifying a property of an eyeglass lens as described above. The method includes the step of sliding a major surface of one apparatus against a major surface of another apparatus.

In a fifth embodiment, the present invention provides a punch cutting apparatus. The apparatus includes a first ram having a first cutting edge disposed about the perimeter of a recess and a second ram having a second cutting edge disposed about the perimeter of a raised portion having a concave surface facing the recess of the first ram. The recess of the first ram is sized and shaped to receive the raised portion of the second ram when in an engaged position. The first and second cutting edges are configured to interact when in the engaged position to cut a transparent polymer film disposed between the rams. The concave surface of the second ram is configured interact with the transparent polymer film to impart a concave shape to the transparent polymer film disposed between the rams when in the engaged position.

In a sixth embodiment, the present invention provides a method of forming an apparatus for modifying a property of an eyeglass lens similar to those described above. The method includes steps of: (i) forming a master sheet of transparent polymer film capable absorbing or reflecting UVA and/or UVB radiation; (ii) placing the master sheet between the rams of the punch cutting apparatus described above; (iii) placing the punch cutting apparatus into an engaged position. When in the engaged position: the raised portion of the second ram is received within the recess of the first ram; the first and second cutting edges interact to cut the master sheet of transparent polymer film disposed between the rams; and the concave surface of the second ram interacts with the transparent polymer film to impart a concave shape to the transparent polymer film disposed between the rams. Upon completion of these steps the method forms an apparatus for modifying a property of an eyeglass lens, which is a seventh embodiment of the present invention.

### DESCRIPTION OF THE DRAWING

FIG. 1 shows a disposable film in accordance with an embodiment of the present invention.

FIG. 2 shows a combination of eyeglasses and disposable films installed thereon in accordance with an embodiment of the present invention.

FIG. 3 shows a stack of disposable films in accordance with an embodiment of the present invention.

FIG. 4 shows a stack of disposable films in packaging in accordance with an embodiment of the present invention

FIGS. 5A and 5B show a punch cutting apparatus in accordance with embodiments of the present invention.

FIG. 6 shows a product produced by methods of the present invention.

### DETAILED DESCRIPTION

The present invention solves problems in the art with respect to prescription eyeglasses and users thereof. In particularly preferred embodiments, the present invention allows a user to carry a single set of prescription eyeglasses that can be used in various light conditions. In accordance with a first embodiment, and as shown in FIG. 1, the present invention provides an apparatus 101 for modifying a property of an eyeglass lens. The apparatus 101 comprises a transparent polymer film capable absorbing or reflecting UVA and/or UVB radiation.

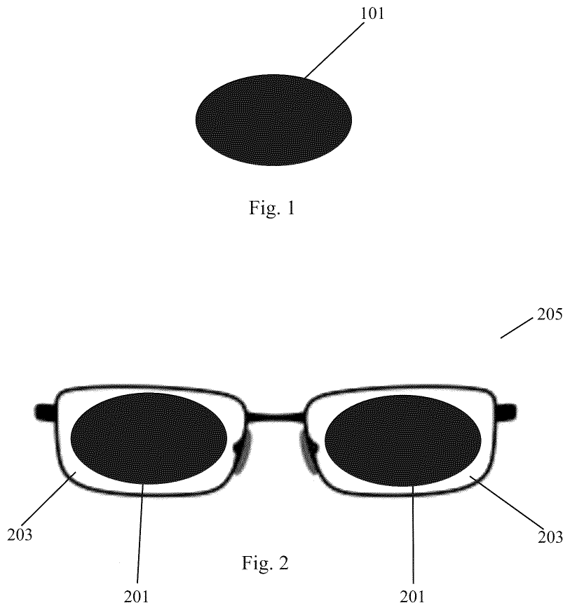

As shown in FIG. 2, the apparatus 201 and/or film is sized and shaped for attachment to a surface the eyeglass 205 lens 203. Here the films 201 are attached to the lenses 203 via electrostatic charge.

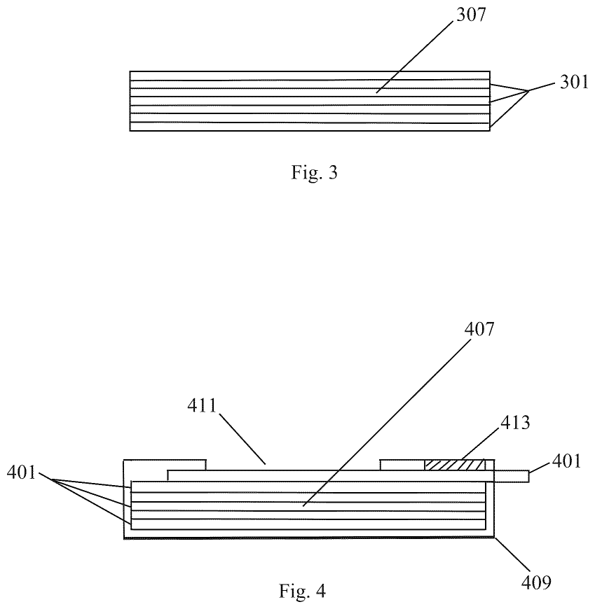

In preferred embodiments, and as shown in FIG. 3, the apparatus/polymer films 301 of the present invention are preferably manufactured and packaged in a stacked configuration 307 wherein the films are stacked directly on top of each other (e.g. wherein major surfaces of adjacent films are in contact with one another).

In additionally preferred embodiments, the stacked films 407 are preferably enclosed within a housing 409 for distribution to end consumers for their use. Here individual films 401 can be removed from the stacked films 407 and from the housing 409 via an opening (not shown). In this embodiment, a user can manipulate an individual film 401 via finger/thumb access port 411 and remove the strip 401 from the stack 407 by sliding the film along the major surface of the underlying film as it exits the housing 409.

In accordance with additional embodiments of the present invention, sliding the major surface of one film 401 against the major surface of an adjacent film creates (or increases) an electrostatic charge on the film 401. This electrostatic charge can then be employed for creating the attachment force necessary for the film to adhere to the surface of a prescription glass lens without the need of adhesives and the associated residues, etc. In the embodiment shown in FIG. 4, a piece of wool or cloth 413 can be positioned with in the housing 409 such that the film 401 is biased toward and slides against the wool/cloth 413 as it is removed from the housing 409. This action allows for the provision of yet additional electrostatic charge to the film which can be used as further adhesion force to the target lens.

In view of the above, and in yet another embodiment, the present invention provides a method of imparting an electrostatic charge to an apparatus/film as described herein (optionally from the kits and housings herein described). The method includes sliding a major surface of one apparatus against a major surface of another apparatus and/or against wool or cloth.

The apparatus/polymer films of the present invention preferably contain a thin film of a flexible polymer material. The apparatus/polymer film is preferably disposable and/or biodegradable and preferably is composed of biodegradable polymers. Such biodegradable polymers are not limited and include polysaccharides, polyoxides, polyesters, polyethylene and polysorbides among many others. In other embodiment, the thin film is durable and can withstand washing, drying, and reuse for example washing with soap and water or solvent cleaning system etc.

The methods of manufacturing and the material of construction of the thin film is not limited. Exemplary methods of manufacturing the thin film material include solvent casting, extrusion, vapor deposition, etc. Such methods preferably are performed such that an optical quality film can be produced and employed in the apparatus, kits, and methods of the present invention.

The films of the present invention are manufactured and packaged for distribution in varying sizes and shapes. In preferred embodiments, the disposable films are square, rectangular, oval or circular in shape and have two major (e.g. preferably flat) surfaces. In other embodiments, the disposable films have a maximum overall dimension (e.g. length and/or width) of less than 8 cm, for example between 2 and 6 cm, between 3 and 7cm, such as between 4 and 6 cm, for example 5 cm. In other embodiments the dimensions of the films are equal to or between 25 mm×40 mm and 35 mm×55 mm, such as 30 mm high by 50 mm wide. The films are also thin wherein in some embodiments have a thickness of between 0.0035 and 0.0085 inches.

The apparatuses/films of the present invention will be manufactured with one or more ingredients (e.g. polymerization monomers) and/or additives such that when applied to a lens of an eyeglass the apparatus will change one or more optical properties of the eyeglass. In these embodiments, the preferred additives and/or polymer and/or monomer provide UVA and UVB absorption and/or reflectance to the apparatus. In other embodiments, the one or more additives are effective to change or alter the tint, color, glare (e.g. anti-glare etc.) shade, light/electromagnetic radiation transmission, etc. For example, in other embodiments the films can reduce the visible light transmission through the film (and hence the lens) by 10-80%, for example by 25-75%, etc. In other embodiments, the apparatus/film contains a polarizing/polarization filter which reduces polarized light (e.g. reflected light) transmission through the film (and hence the lens) by 10-80%, for example by 25-75%, etc.

### Punch Cutting Apparatus, Method of its Use, and Product by Process

Punching thin polymer films to form smaller films of flat two-dimensional geometric shapes using upper and lower punches is a known process. In additional embodiments, the present invention provides a punch cutting apparatus and method of its use, which form three-dimensional shaped transparent polymer films. The films produced by this process have a concave or convex shape which can resemble, mimic, or match the contour of an eyeglass lens which can be used in the kits and the film apparatus embodiments of the present invention for placement on lenses of eyeglasses to change the visible properties thereof.

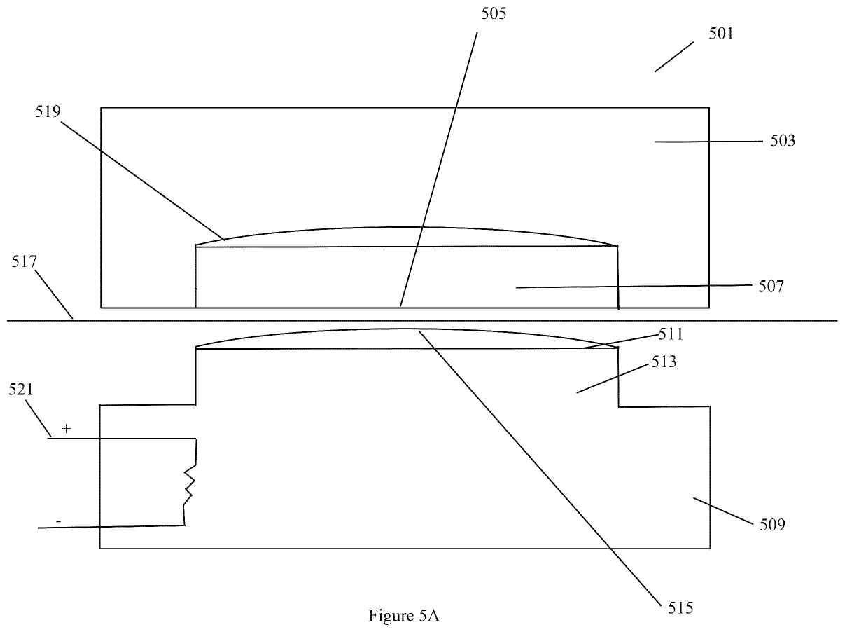

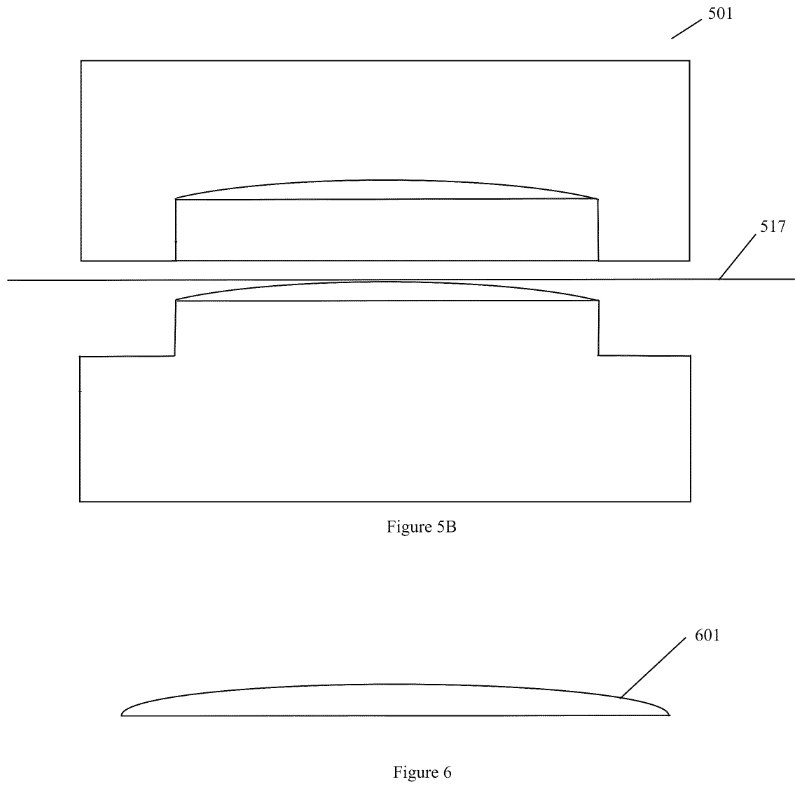

In preferred embodiments, and as shown in FIGS. 5A and 5B, the present invention provides a punch cutting apparatus 501. The apparatus includes a first ram 503 having a first cutting edge 505 disposed about the perimeter of a recess 507 and a second ram 509 having a second cutting edge 511 disposed about the perimeter of a raised portion 513 having a concave surface 515 facing the recess 507 of the first ram 503. The recess 507 of the first ram 503 is sized and shaped to receive the raised portion 513 of the second ram when in being placed into an engaged position with the film (shown in FIG. 5B). The first 505 and second 511 cutting edges are configured to interact with each other when in the engaged position to cut a master sheet of transparent polymer film 517 disposed between the rams 503, 509. The concave surface 515 of the second ram 509 is configured interact with the transparent polymer film 517 to impart a concave shape to the transparent polymer film 517 disposed between the rams 503, 509 when in the engaged position. Optionally the recess 507 in first ram 503 includes a mating convex surface 519 to engage with the concave surface 515 of the second ram 509 when in an engaged position. In a preferred embodiment, the apparatus includes a heating element 521 configured to heat the film 517 disposed between the rams 503, 509 when in the engaged position.

In another embodiment, the present invention provides a method of using the punch cutting apparatus described above with respect to FIGS. 5A and 5B. In a preferred embodiment the method is used to form an apparatus for modifying a property of an eyeglass lens, the apparatus having a transparent polymer film capable absorbing or reflecting UVA and/or UVB radiation, wherein the film is sized and shaped for attachment to a surface the eyeglass lens and has a concave shape. The method includes a first step of (i) forming a master sheet of transparent polymer film capable absorbing or reflecting UVA and/or UVB radiation. In a second step a (ii) the master sheet is placed between the rams of the punch cutting apparatus described herein. In a third step, (iii) the punch cutting apparatus is placed into an engaged position (as shown in FIG. 5B). When in the engaged position: the raised portion of the second ram is received within the recess of the first ram; the first and second cutting edges interact to cut the master sheet of transparent polymer film disposed between the rams; and the concave surface of the second ram interacts with the transparent polymer film to impart a concave shape to the transparent polymer film disposed between the rams. Upon completion of these steps the apparatus for modifying a property of an eyeglass lens is formed.

In another embodiment, the present invention provides a product (shown in FIG. 6 and 601) formed by the method of using the punch cutting apparatus described above. The product 601 is new and novel for example inter alia such method can be used to form three-dimensional thin film product for modifying the properties of an eyeglass lens as herein described.

1. An apparatus for modifying a property of an eyeglass lens, the apparatus comprising:
a transparent disposable polymer film capable absorbing or reflecting UVA and/or UVB radiation, wherein the film:
is capable of absorbing or reflecting some but not all visible electromagnetic radiation;
has a length dimension and a width dimension, wherein the length dimension and the width dimensions do not exceed 8 cm and wherein the film is configured for electrostatic attachment to a surface the eyeglass lens without use of an adhesive;
has no adhesive layer;
is disposed on a backing layer; and
has a concave shape.

2. (canceled)

3. The apparatus of claim 1, further comprising an electrostatic charge when removed from the backing layer.

4. The apparatus of claim 1, further comprising a polarizing filter.

5. The apparatus of claim 1, wherein the apparatus is biodegradable and further comprises a biodegradable polymer selected from the group consisting of: polysaccharide and polysorbide.

6. (canceled)

7. (canceled)

8. (canceled)

9. An eyeglass lens combination comprising an eyeglass lens having a concave shape and an apparatus according to claim 1, wherein the film is attached to the lens via electrostatic attraction and without the use of an adhesive.

10. (canceled)

11. The eyeglass lens combination of claim 9, wherein the concave shape of the film is substantially similar to the concave shape of the lens.

12. A kit comprising a plurality of new and unused apparatuses of claim 1, wherein the plurality of apparatuses are arranged in a stacked configuration.

13. The kit of claim 12, wherein the kit further comprises a housing, wherein the arranged stack of new and unused apparatuses are disposed within the housing, wherein the housing further comprises a piece of wool or cloth disposed near an opening of the housing.

14. A method of imparting an electrostatic charge to an apparatus of claim 1, comprising the step of sliding a major surface of one apparatus against a major surface of another apparatus or by separating the film from the backing layer.

15. The method of claim 14, wherein the method further includes the step of sliding a major surface of the apparatus against wool and/or cloth.

16. A punch cutting apparatus comprising a first rani having a first cutting edge disposed about the perimeter of a recess and a second ram having a second cutting edge disposed about the perimeter of a raised portion having a concave surface facing the recess of the first ram, wherein: the recess of the first ram is sized and shaped to receive the raised portion of the second ram when in an engaged position; the first and second cutting edges are configured to interact when in the engaged position to cut a transparent polymer film disposed between the rams; the concave surface of the second ram is configured interact with the transparent polymer film to impart a concave shape to the transparent polymer film disposed between the rams when in the engaged position.

17. The punch cutting apparatus of claim 16, wherein the recess in first ram comprises a mating convex surface to engage with the concave surface of the second rain when in an engaged position.

18. The punch cutting apparatus of claim 16, further comprising a heating element to heat the film disposed between the rams when in the engaged position.

19. A method of forming the apparatus of claim 1, the apparatus having a transparent polymer film capable absorbing or reflecting UVA and/or UVB radiation, wherein the film is sized and shaped for attachment to a surface the eyeglass lens and has a concave shape, the method comprising the steps of:
(i) forming a master sheet of transparent polymer film capable absorbing or reflecting UVA and/or UVB radiation,
(ii) placing the master sheet between the rams of the punch cutting apparatus comprising a first ram having a first cutting edge disposed about the perimeter of a recess and a second ram having a second cutting edge disposed about the perimeter of a raised portion having a concave surface facing the recess of the first ram, wherein: the recess of the first ram is sized and shaped to receive the raised portion of the second ram when in an engaged position; the first and second cutting edges are configured to interact when in the engaged position to cut a transparent polymer film disposed between the rams; the concave surface of the second ram is configured interact with the transparent polymer film to impart a concave shape to the transparent polymer film disposed between the rams when in the engaged position,
(iii) placing the punch cutting apparatus into an engaged position, wherein: the raised portion of the second ram is received within the recess of the first ram; the first and second cutting edges interact to cut the master sheet of transparent polymer film disposed between the rams; and the concave surface of the second ram interacts with the transparent polymer film to impart a concave shape to the transparent polymer film disposed between the rams,
thereby forming the apparatus of claim 1.

20. (canceled)

21. The kit of claim 12, wherein the kit comprises at least six new and unused apparatuses arranged in a stacked configuration.

22. The kit of claim 12, wherein the plurality of apparatuses are arranged in a stacked configuration, wherein a major surface of a first film faces a major surface of a second film and is separated by the backing layer of either of both the first film and/or the second film.

23. The apparatus of claim 1, wherein the length dimension and the width dimensions are between 2 and 6 cm and the film has a thickness between 0.0035 and 0.0085 inches.
